(19) United States
(12) Patent Application Publication
(10) Pub. No.: US 2007/0118372 A1
(43) Pub. Date: May 24, 2007

(54) System and method for generating closed captions

(75) Inventors: Gerald Bowden Wise, Clifton Park, NY (US); Louis John Hoebel, Burnt Hills, NY (US); John Michael Lizzi, Albany, NY (US); Wei Chai, Niskayuna, NY (US); Helena Goldfarb, Niskayuna, NY (US); Anil Abraham, Latham, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/287,556

(22) Filed: Nov. 23, 2005

(51) Int. Cl. G10L 15/26

(52) U.S. Cl. 704/235

(57) ABSTRACT

A system for generating closed captions is provided. The system includes a speech recognition engine configured to generate one or more text transcripts corresponding to one or more speech segments from an audio signal. The system further includes a processing engine, one or more context-based models and an encoder. The processing engine is configured to process the text transcripts. The context-based models are configured to identify an appropriate context associated with the text transcripts. The encoder is configured to broadcast the text transcripts corresponding to the speech segments as closed captions.

### BACKGROUND

The invention relates generally to generating closed captions and more particularly to a system and method for automatically generating closed captions using speech recognition.

Closed captioning is the process by which an audio signal is translated into visible textual data. The visible textual data may then be made available for use by a hearing-impaired audience in place of the audio signal. A caption decoder embedded in televisions or video recorders generally separates the closed caption text from the audio signal and displays the closed caption text as part of the video signal.

Speech recognition is the process of analyzing an acoustic signal to produce a string of words. Speech recognition is generally used in hands-busy or eyes-busy situations such as when driving a car or when using small devices like personal digital assistants. Some common applications that use speech recognition include human-computer interactions, multi-modal interfaces, telephony, dictation, and multimedia indexing and retrieval. The speech recognition requirements for the above applications, in general, vary, and have differing quality requirements. For example, a dictation application may require near real-time processing and a low word error rate text transcription of the speech, whereas a multimedia indexing and retrieval application may require speaker independence and much larger vocabularies, but can accept higher word error rates.

### BRIEF DESCRIPTION

Embodiments of the invention provide a system for generating closed captions. The system includes a speech recognition engine configured to generate one or more text transcripts corresponding to one or more speech segments from an audio signal. The system further includes a processing engine, one or more context-based models and an encoder. The processing engine is configured to process the text transcripts. The context-based models are configured to identify an appropriate context associated with the text transcripts. The encoder is configured to broadcast the text transcripts corresponding to the speech segments as closed captions.

In another embodiment, a method for automatically generating closed captioning text is provided. The method includes obtaining one or more speech segments from an audio signal. Then, the method includes generating one or more text transcripts corresponding to the one or more speech segments and identifying an appropriate context associated with the text transcripts. The method then includes processing the one or more text transcripts and broadcasting the text transcripts corresponding to the speech segments as closed captioning text.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a system for generating closed captions in accordance with one embodiment of the invention;

FIG. 2 illustrates a system for identifying an appropriate context associated with text transcripts, using context-based models and topic-specific databases in accordance with one embodiment of the invention; and

FIG. 3 illustrates a process for automatically generating closed captioning text in accordance with embodiments of the present invention.

### DETAILED DESCRIPTION OF PREFERRED EMBODIMENTS

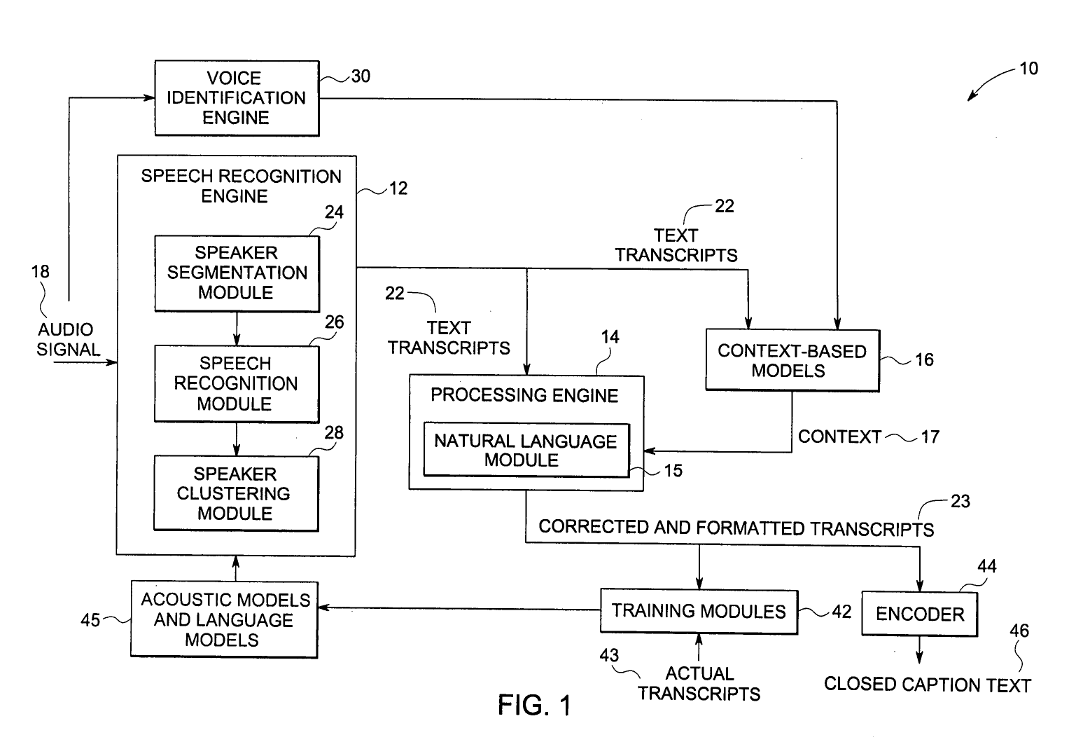

FIG. 1 is an illustration of a system 10 for generating closed captions in accordance with one embodiment of the invention. As shown in FIG. 1, the system 10 generally includes a speech recognition engine 12, a processing engine 14 and one or more context-based models 16. The speech recognition engine 12 receives an audio signal 18 and generates text transcripts 22 corresponding to one or more speech segments from the audio signal 18. The audio signal may include a signal conveying speech from a news broadcast, a live or recorded coverage of a meeting or an assembly, or from scheduled (live or recorded) network or cable entertainment. In certain embodiments, the speech recognition engine 12 may further include a speaker segmentation module 24, a speech recognition module 26 and a speaker-clustering module 28. The speaker segmentation module 24 converts the incoming audio signal 18 into speech and non-speech segments. The speech recognition module 26 analyzes the speech in the speech segments and identifies the words spoken. The speaker-clustering module 28 analyzes the acoustic features of each speech segment to identify different voices, such as, male and female voices, and labels the segments in an appropriate fashion.

The context-based models 16 are configured to identify an appropriate context 17 associated with the text transcripts 22 generated by the speech recognition engine 12. In a particular embodiment, and as will be described in greater detail below, the context-based models 16 include one or more topic-specific databases to identify an appropriate context 17 associated with the text transcripts. In a particular embodiment, a voice identification engine 30 may be coupled to the context-based models 16 to identify an appropriate context of speech and facilitate selection of text for output as captioning. As used herein, the “context” refers to the speaker as well as the topic being discussed. Knowing who is speaking may help determine the set of possible topics (e.g., if the weather anchor is speaking, topics will be most likely limited to weather forecasts, storms, etc.). In addition to identifying speakers, the voice identification engine 30 may also be augmented with non-speech models to help identify sounds from the environment or setting (explosion, music, etc.). This information can also be utilized to help identify topics. For example, if an explosion sound is identified, then the topic may be associated with war or crime.

The voice identification engine 30 may further analyze the acoustic feature of each speech segment and identify the specific speaker associated with that segment by comparing the acoustic feature to one or more statistical models corresponding to a set of possible speakers and determining the closest match based upon the comparison. The speaker models may be trained offline and loaded by the voice identification engine 30 for real-time speaker identification. For purposes of accuracy, a smoothing/filtering step may be performed before presenting the identified speakers to avoid instability (generally caused due to unrealistic high frequency of changing speakers) in the system.

The processing engine 14 processes the text transcripts 22 generated by the speech recognition engine 12. The processing engine 14 includes a natural language module 15 to analyze the text transcripts 22 from the speech recognition engine 12 for word errors. In particular, the natural language module 15 performs word error correction, named-entity extraction, and output formatting on the text transcripts 22. A word error correction of the text transcripts is generally performed by determining a word error rate corresponding to the text transcripts. The word error rate is defined as a measure of the difference between the transcript generated by the speech recognizer and the correct reference transcript. In some embodiments, the word error rate is determined by calculating the minimum edit distance in words between the recognized and the correct strings. Named entity extraction processes the text transcripts 22 for names, companies, and places in the text transcripts 22. The names and entities extracted may be used to associate metadata with the text transcripts 22, which can subsequently be used during indexing and retrieval. Output formatting of the text transcripts 22 may include, but is not limited to, capitalization, punctuation, word replacements, insertions and deletions, and insertions of speaker names.

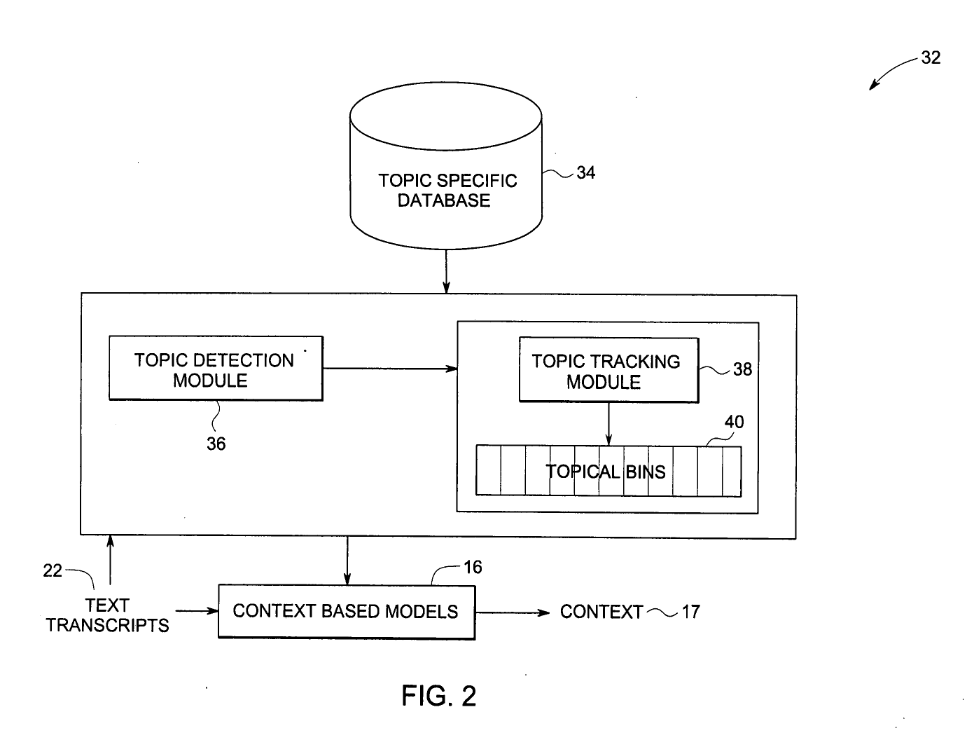

FIG. 2 illustrates a system for identifying an appropriate context associated with text transcripts, using context-based models and topic-specific databases in accordance with one embodiment of the invention. As shown in FIG. 2, the system 32 includes a topic-specific database 34. The topic-specific database 34 may include a text corpus, comprising a large collection of text documents. The system 32 further includes a topic detection module 36 and a topic tracking module 38. The topic detection module 36 identifies a topic or a set of topics included within the text transcripts 22. The topic tracking module 38 identifies particular text-transcripts 22 that have the same topic(s) and categorizes stories on the same topic into one or more topical bins 40.

Referring to FIG. 1, the context 17 associated with the text transcripts 22 identified by the context based models 16 is further used by the processing engine 16 to identify incorrectly recognized words and identify corrections in the text transcripts, which may include the use of natural language techniques. In a particular example, if the text transcripts 22 include a phrase, “she spotted a sale from far away” and the topic detection module 16 identifies the topic as a “beach” then the context based models 16 will correct the phrase to “she spotted a sail from far away”.

In some embodiments, the context-based models 16 analyze the text transcripts 22 based on a topic specific word probability count in the text transcripts. As used herein, the “topic specific word probability count” refers to the likelihood of occurrence of specific words in a particular topic wherein higher probabilities are assigned to particular words associated with a topic than with other words. For example, as will be appreciated by those skilled in the art, words like “stock price” and “DOW industrials” are generally common in a report on the stock market but not as common during a report on the Asian tsunami of December 2004, where words like “casualties,” and “earthquake” are more likely to occur. Similarly, a report on the stock market may mention “Wall Street” or “Alan Greenspan” while a report on the Asian tsunami may mention “Indonesia” or “Southeast Asia”. The use of the context-based models 16 in conjunction with the topic-specific database 34 improves the accuracy of the speech recognition engine 12. In addition, the context-based models 16 and the topic-specific databases 34 enable the selection of more likely word candidates by the speech recognition engine 12 by assigning higher probabilities to words associated with a particular topic than other words.

Referring to FIG. 1, the system 10 further includes a training module 42. In accordance with one embodiment, the training module 42 manages acoustic models and language models 45 used by the speech recognition engine 12. The training module 42 augments dictionaries and language models for speakers and builds new speech recognition and voice identification models for new speakers. The training module 42 uses actual transcripts 43 to identify new words resulting from the audio signal based on an analysis of a plurality of text transcripts and updates the acoustic models and language models 45 based on the analysis. As will be appreciated by those skilled in the art, acoustic models are built by analyzing many audio samples to identify words and sub-words (phonemes) to arrive at a probabilistic model that relates the phonemes with the words. In a particular embodiment, the acoustic model used is a Hidden Markov Model (HMM). Similarly, language models may be built from many samples of text transcripts to determine frequencies of individual words and sequences of words to build a statistical model. In a particular embodiment, the language model used is an N-grams model. As will be appreciated by those skilled in the art, the N-grams model uses a sequence of N words in a sequence to predict the next word, using a statistical model.

An encoder 44 broadcasts the text transcripts 22 corresponding to the speech segments as closed caption text 46. The encoder 44 accepts an input video signal, which may be analog or digital. The encoder 44 further receives the corrected and formatted transcripts 23 from the processing engine 14 and encodes the corrected and formatted transcripts 23 as closed captioning text 46. The encoding may be performed using a standard method such as, for example, using line 21 of a television signal. The encoded, output video signal may be subsequently sent to a television, which decodes the closed captioning text 46 via a closed caption decoder. Once decoded, the closed captioning text 46 may be overlaid and displayed on the television display.

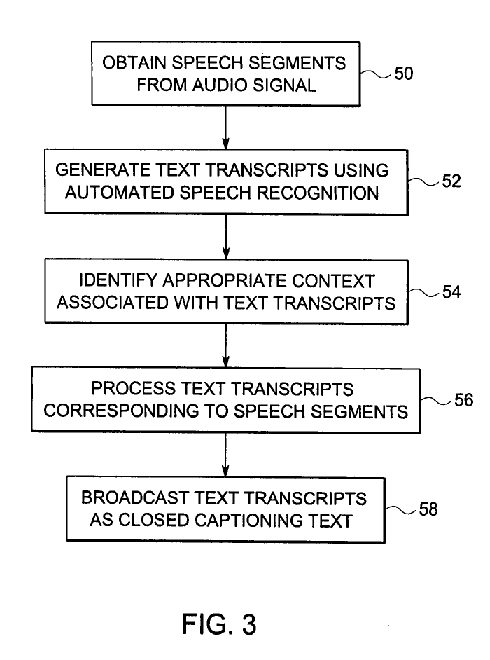

FIG. 3 illustrates a process for automatically generating closed captioning text, in accordance with embodiments of the present invention. In step 50, one or more speech segments from an audio signal are obtained. The audio signal 18 (FIG. 1) may include a signal conveying speech from a news broadcast, a live or recorded coverage of a meeting or an assembly, or from scheduled (live or recorded) network or cable entertainment. Further, acoustic features corresponding to the speech segments may be analyzed to identify specific speakers associated with the speech segments. In one embodiment, a smoothing/filtering operation may be applied to the speech segments to identify particular speakers associated with particular speech segments. In step 52, one or more text transcripts corresponding to the one or more speech segments are generated. In step 54, an appropriate context associated with the text transcripts 22 is identified. As described above, the context 17 helps identify incorrectly recognized words in the text transcripts 22 and helps the selection of corrected words. Also, as mentioned above, the appropriate context 17 is identified based on a topic specific word probability count in the text transcripts. In step 56, the text transcripts 22 are processed. This step includes analyzing the text transcripts 22 for word errors and performing corrections. In one embodiment, the text transcripts 22 are analyzed using a natural language technique. In step 58, the text transcripts are broadcast as closed captioning text.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for generating closed captions, the system comprising:
a speech recognition engine configured to generate from an audio signal one or more text transcripts corresponding to one or more speech segments;
one or more context-based models configured to identify an appropriate context associated with the text transcripts;
a processing engine configured to process the text transcripts; and
an encoder configured to broadcast the text transcripts corresponding to the speech segments as closed captions.

2. The system of claim 1, further comprising a voice identification engine coupled to the one or more context-based models, wherein the voice identification engine is configured to analyze acoustic features corresponding to the speech segments to identify specific speakers associated with the speech segments

3. The system of claim 2, wherein the voice identification engine is further configured to filter the speech segments to identify a particular speaker associated with a particular speech segment.

4. The system of claim 1, wherein the processing engine is adapted to analyze the text transcripts corresponding to the speech segments for word errors.

5. The system of claim 4, wherein the processing engine includes a natural language module for analyzing the text transcripts.

6. The system of claim 1, wherein the context-based models include one or more topic-specific databases for identifying an appropriate context associated with the text transcripts.

7. The system of claim 6, wherein the context-based models are adapted to identify the appropriate context based on a topic specific word probability count in the text transcripts corresponding to the speech segments.

8. The system of claim 1, wherein the speech recognition engine is coupled to a training module, wherein the training module is configured to augment dictionaries and language models for speakers by analyzing actual transcripts and build new speech recognition and voice identification models for new speakers.

9. The system of claim 8, wherein the training module is configured to manage acoustic and language models used by the speech recognition engine.

10. A method for automatically generating closed captioning text, the method comprising:
obtaining one or more speech segments from an audio signal;
generating one or more text transcripts corresponding to the one or more speech segments;
identifying an appropriate context associated with the text transcripts;
processing the one or more text transcripts; and
broadcasting the text transcripts corresponding to the speech segments as closed captioning text.

11. The method of claim 10, comprising analyzing acoustic features corresponding to the speech segments to identify specific speakers associated with the speech segments.

12. The method of claim 11, comprising applying a filtering operation to the speech segments to identify a particular speaker associated with a particular speech segment.

13. The method of claim 10, wherein processing one or more text transcripts comprises analyzing the text transcripts for word errors.

14. The method of claim 13, wherein the analyzing the text transcripts is performed using a natural language technique.

15. The method of claim 10, wherein the identifying an appropriate context comprises utilizing one or more topic specific databases.

16. The method of claim 15, wherein the identifying an appropriate context is based on a topic specific word probability count in the text transcripts corresponding to the speech segments.

17. The method of claim 10, comprising augmenting dictionaries and language models for speakers by analyzing actual transcripts and building new speech recognition and voice identification models for new speakers.

18. The method of claim 17, wherein the analyzing is performed using at least one of acoustic modeling techniques or language modeling techniques.

19. A method for generating closed captions, the method comprising:
obtaining one or more text transcripts corresponding to one or more speech segments from an audio signal;
identifying an appropriate context associated with the one or more text transcripts based on a topic specific word probability count in the text transcripts;
processing the one or more text transcripts for word errors; and
broadcasting the one or more text transcripts as closed captions in conjunction with the audio signal.

20. A computer-readable medium storing computer instructions for instructing a computer system for generating closed captions, the computer instructions comprising:
obtaining one or more text transcripts corresponding to one or more speech segments from an audio signal;
identifying an appropriate context associated with the one or more text transcripts; and
processing the one or more text transcripts for word errors; and
broadcasting the one or more text transcripts corresponding to the speech segments as closed captions.
